(19) United States
(12) Patent Application Publication
(10) Pub. No.: US 2025/0380328 A1
(43) Pub. Date: Dec. 11, 2025

(54) FORWARDING CONTROL METHOD AND INFORMATION TRANSMISSION METHOD AND APPARATUS

(71) Applicant: VIVO MOBILE COMMUNICATION CO., LTD., Dongguan (CN)

(72) Inventor: Jinhua LIU, Dongguan (CN)

(73) Assignee: VIVO MOBILE COMMUNICATION CO., LTD., Dongguan (CN)

(21) Appl. No.: 19/300,641

(22) Filed: Aug. 14, 2025

Related U.S. Application Data
(63) Continuation of application No. PCT/CN2024/076497, filed on Feb. 7, 2024.

(30) Foreign Application Priority Data
Feb. 14, 2023 (CN) 202310124046.3

(51) Int. Cl. H04W 76/27

(52) U.S. Cl. CPC H04W 76/27

(57) ABSTRACT

This application discloses a forwarding control method, and an information transmission method and apparatus. The forwarding control method includes: receiving, by a layer-1 forwarding node, first forwarding configuration information from a network side device when a mobile termination module (MT) of the later-1 forwarding node is in a radio resource control (RRC) connected state; and performing, by the layer-1 forwarding node, forwarding based on the first forwarding configuration information when the MT of the layer-1 forwarding node enters a first state, where the first states includes an RRC idle state or an RRC inactive state.

### CROSS-REFERENCE TO RELATED APPLICATIONS

This application is a continuation of International Application No. PCT/CN2024/076497, filed Feb. 7, 2024, which claims priority to Chinese Patent Application No. 202310124046.3, filed Feb. 14, 2023. The entire contents of each of the above-referenced applications are expressly incorporated herein by reference.

### TECHNICAL FIELD

This application pertains to the field of communication technologies, and specifically relates to a forwarding control method and an information transmission method and apparatus.

### BACKGROUND

In a related technology, after a Network Controlled Repeater-Mobile Termination (NCR-MT) enters a Radio Resource Control (RRC) inactive (INACTIVE) state, an NCR forwarding unit (NCR Forwarding, NCR-FWD) may continue to perform forwarding. However, after the NCR-MT is released to the RRC INACTIVE state or an RRC IDLE state, a wireless connection between a base station and the NCR-MT is released, and a corresponding radio resource is also released. The base station cannot send side control information to the NCR-MT to control a forwarding behavior of the NCR-FWD. In this way, if the NCR-FWD continues to perform a forwarding operation, the NCR-FWD cannot perform forwarding based on an air interface scheduling status of the base station, resulting in reduced forwarding performance, invalid forwarding, forwarding of an interference signal, and the like.

### SUMMARY

Embodiments of this application provide a forwarding control method and an information transmission method and apparatus, to provide how, when an NCR-MT enters an RRC inactive state or an RRC idle state, the NCR-MT controls forwarding behavior of an NCR-FWD based on forwarding configuration information received before being released to the RRC inactive state or the RRC idle state, so that the forwarding behavior of the NCR-FWD after the NCR-MT enters the RRC inactive state or the RRC idle state is controllable.

According to a first aspect, a forwarding control method is provided, and the method includes:
receiving, by a layer-1 forwarding node, first forwarding configuration information from a network side device when a mobile termination module MT of the layer-1 forwarding node is in a radio resource control RRC connected state; and
performing, by the layer-1 forwarding node, forwarding based on the first forwarding configuration information when the MT of the layer-1 forwarding node enters a first state, where the first state includes an RRC idle state or an RRC inactive state.

According to a second aspect, a forwarding control apparatus is provided, where the forwarding control apparatus is applied to a layer-1 forwarding node, and the apparatus includes:
a first receiving module, configured to receive first forwarding configuration information from a network side device when a mobile termination module MT of the layer-1 forwarding node is in a radio resource control RRC connected state; and
a first execution module, configured to perform forwarding based on the first forwarding configuration information when the MT of the layer-1 forwarding node enters a first state, where the first state includes an RRC idle state or an RRC inactive state.

According to a third aspect, an information transmission method is provided, and the method includes:
sending, by a network side device, first forwarding configuration information to a layer-1 forwarding node when a mobile termination module MT of the layer-1 forwarding node is in a radio resource control RRC connected state, where the first forwarding configuration information is used to configure forwarding behavior of the layer-1 forwarding node when the MT of the layer-1 forwarding node enters a first state, and the first state includes an RRC idle state or an RRC inactive state.

According to a fourth aspect, an information transmission apparatus is provided, where the information transmission method is applied to a network side device, and the apparatus includes:
a first sending module, configured to send first forwarding configuration information to a layer-1 forwarding node when a mobile termination module MT of the layer-1 forwarding node is in a radio resource control RRC connected state, where the first forwarding configuration information is used to configure forwarding behavior of the layer-1 forwarding node when the MT of the layer-1 forwarding node enters a first state, and the first state includes an RRC idle state or an RRC inactive state.

According to a fifth aspect, a layer-1 forwarding node is provided. The layer-1 forwarding node includes a processor and a memory, the memory stores a program or instructions that are capable of running on the processor, and when the program or the instructions are executed by the processor, the steps of the method according to the first aspect are implemented.

According to a sixth aspect, a layer-1 forwarding node is provided, including a processor and a communication interface. The communication interface is configured to: receive first forwarding configuration information from a network side device when a mobile termination module MT of the layer-1 forwarding node is in a radio resource control RRC connected state; and perform forwarding based on the first forwarding configuration information when the MT of the layer-1 forwarding node enters a first state, where the first state includes an RRC idle state or an RRC inactive state.

According to a seventh aspect, a network side device is provided. The network side device includes a processor and a memory, the memory stores a program or instructions that are capable of running on the processor, and when the program or the instructions are executed by the processor, the steps of the method according to the third aspect are implemented.

According to an eighth aspect, a network side device is provided, including a processor and a communication interface. The communication interface is configured to send first forwarding configuration information to a layer-1 forwarding node when a mobile termination module MT of the layer-1 forwarding node is in a radio resource control RRC connected state, where the first forwarding configuration information is used to configure forwarding behavior of the layer-1 forwarding node when the MT of the layer-1 forwarding node enters a first state, and the first state includes an RRC idle state or an RRC inactive state.

According to a ninth aspect, a communication system is provided, including a layer-1 forwarding node and a network side device. The layer-1 forwarding node may be configured to perform the steps of the forwarding control method according to the first aspect, and the network side device may be configured to perform the steps of the information transmission method according to the third aspect.

According to a tenth aspect, a readable storage medium is provided. The readable storage medium stores a program or instructions, and when the program or the instructions are executed by a processor, the steps of the method according to the first aspect are implemented, or the steps of the method according to the third aspect are implemented.

According to an eleventh aspect, a chip is provided. The chip includes a processor and a communication interface, the communication interface is coupled to the processor, and the processor is configured to run a program or instructions to implement the method according to the first aspect or the method according to the third aspect.

According to a twelfth aspect, a computer program product/program product is provided. The computer program product/program product is stored in a storage medium, and the computer program/program product is executed by at least one processor to implement the steps of the forwarding control method according to the first aspect or the steps of the information transmission method according to the third aspect.

In embodiments of this application, a layer-1 forwarding node receives first forwarding configuration information from a network side device when an MT of the layer-1 forwarding node is in a radio resource control RRC connected state, and the layer-1 forwarding node performs forwarding based on the first forwarding configuration information when the MT of the layer-1 forwarding node enters a first state, where the first state includes an RRC idle state or an RRC inactive state. In this way, the forwarding behavior of the layer-1 forwarding node when the MT of the layer-1 forwarding node is in the RRC idle state or the RRC inactive state can be controlled based on the first forwarding configuration information, so that forwarding performance of the layer-1 forwarding node can be improved.

### BRIEF DESCRIPTION OF DRAWINGS

FIG. 1 is a first schematic diagram of a structure of a wireless communication system to which embodiments of this application can be applied;

FIG. 2 is a second schematic diagram of a structure of a wireless communication system to which embodiments of this application can be applied;

FIG. 3 is a flowchart of a forwarding control method according to an embodiment of this application;

FIG. 4 is a flowchart of an information transmission method according to an embodiment of this application;

FIG. 5 is a schematic diagram of a structure of a forwarding control apparatus according to an embodiment of this application;

FIG. 6 is a schematic diagram of a structure of an information transmission apparatus according to an embodiment of this application;

FIG. 7 is a schematic diagram of a structure of a communication device according to an embodiment of this application; and

FIG. 8 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, “or” in this application represents at least one of connected objects. For example, “A or B” covers three solutions, that is, solution 1: including A and not including B; solution 2: including B and not including A; and solution 3: including A and B. The character “/” generally indicates an “or” relationship between associated objects.

The term “indication” in this application may be either a direct indication (or an explicit indication) or an indirect indication (or an implicit indication). A direct indication may be understood as: A transmitter explicitly notifies, in a transmitted indication, a receiver of content such as specific information, an operation that needs to be performed, or a request content. An indirect indication may be understood as: A receiver determines corresponding information based on an indication sent by a transmitter, or performs determining and determines, based on a determining result, an operation that needs to be performed, a request result, or the like.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), or other systems. The terms “system” and “network” in the embodiments of this application may be used interchangeably. The technologies described can be applied to both the systems and the radio technologies mentioned above as well as to other systems and radio technologies. The following descriptions describe a New Radio (NR) system for example purposes, and NR terms are used in most of the following descriptions, but these technologies can also be applied to a system other than an NR system, for example, a 6^{th} generation (6G) communication system.

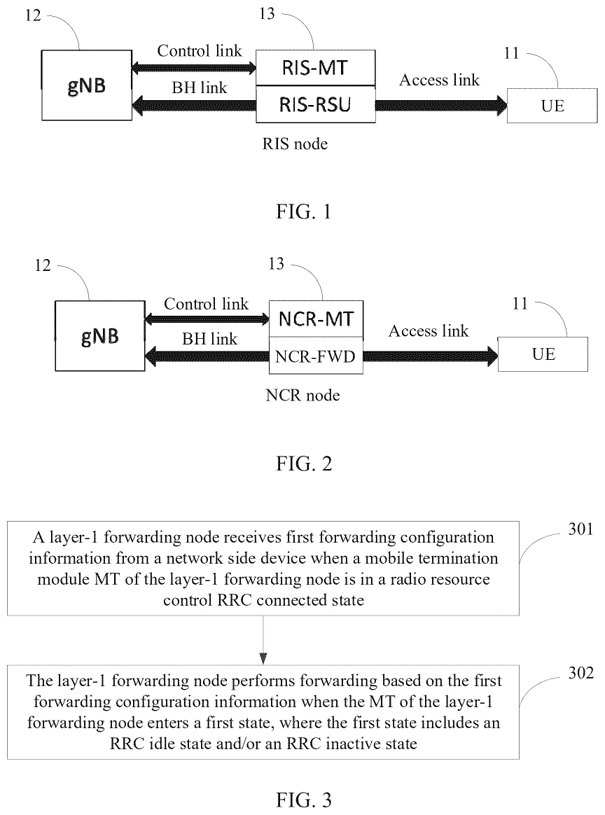

FIG. 1 or FIG. 2 is a block diagram of a wireless communication system to which embodiments of this application may be applied. The wireless communication system includes a terminal 11, a network side device 12, and a layer-1 forwarding node 13. The terminal 11 may be a terminal side device such as a mobile phone, a tablet personal computer, a laptop computer, a notebook computer, a Personal Digital Assistant (PDA), a palmtop computer, a netbook, an Ultra-mobile Personal Computer (UMPC), a Mobile Internet Device (MID), an Augmented Reality (AR) device, a Virtual Reality (VR) device, a robot, a wearable device, a flight vehicle, Vehicle User Equipment (VUE), ship-borne equipment, Pedestrian User Equipment (PUE), a smart home device (a home device with a wireless communication function, such as a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AP), a Wireless Fidelity (WiFi) node, and the like. The base station may be referred to as a NodeB (Node B, NB), an Evolved Node B (eNB), a next-generation node B (gNB), a new radio NodeB (New Radio Node B, NR Node B), an access point, a Relay Base Station (RBS), a Serving Base Station (SBS), a Base Transceiver Station (BTS), a radio base station, a radio transceiver, a Basic Service Set (BSS), an Extended Service Set (ESS), a home NodeB (HNB), a home evolved NodeB, a Transmission Reception Point (TRP), or another suitable term in the field, provided that a same technical effect is achieved, and the base station is not limited to a specific technical vocabulary. The layer-1 forwarding node 13 may be a forwarding node that forwards a radio frequency signal between the network side device 12 and the terminal 11 under the control of the network side device 12, such as a Reconfigurable Intelligent Surface (RIS) or a Network Controlled Repeater (NCR). It should be noted that the embodiments of this application are generally described by using an example in which the network side device 12 is a base station in an NR system, the terminal 11 is User Equipment (UE), and the layer-1 forwarding node 13 is an NCR node. Specific types of the network side device, the terminal, and the layer-1 forwarding node are not limited.

### For an RIS Node

The RIS has different implementations. The RIS may be modeled as an RIS mobile termination module (RIS-Mobile Termination, RIS-MT) and a reflection plane unit (RIS-Reflection Surface Unit, RIS-RSU). In a logical structure of the RIS node shown in FIG. 1, the RIS-MT is used by the RIS node to establish a wireless connection to a serving base station, to send a measurement report of the RIS node and reflection control signaling of the RIS node to the base station; and the RIS-RSU is configured to perform signal reflection and transmission between the base station and UE, including a synchronization signal/physical broadcast channel signal block (Synchronization Signal and PBCH block, SSB), a system message, uplink/downlink dedicated signaling, an uplink/downlink control channel, an uplink/downlink data signal, and the like. The RIS-MT may use an independent antenna, or may share an antenna on the RIS-RSU. There is an RIS-RSU control unit (for example, a panel controller) between the RIS-MT and the RIS-RSU. The RIS-MT sends a received RIS-RSU control command to the RIS-RSU control unit, and the RIS-RSU control unit controls the RIS-RSU. The base station may control a transmit parameter of the RIS-RSU, including incident and reflected beam parameters, by sending signaling used to control the RIS-RSU to the RIS-MT. The RIS-RSU unit of the RIS node is a passive radio signal incident/reflection panel, and includes a reflection array formed by several incident/reflection units. The base station may configure a phase-amplitude matrix of the incident/reflection array to achieve an objective of controlling a reflected beam of the RIS-RSU.

A reflection effect of the RIS-RSU has the following plurality of effects:
1. Effective reflection: Under the control of the base station, a target signal is reflected to a direction of target UE, so that an effective signal received by the target UE is enhanced.
2. Interference reflection 1: When reflection is not scheduled by the base station, all received signals are reflected to a direction pointed to by a current reflection array, and this causes interference.
3. Interference reflection 2: When reflection is scheduled by the base station, when all received target signals are reflected, a generated sidelobe transmits a target signal to a non-target direction, and this causes interference in the non-target direction.
4. Out-of-band reflection: The RIS-RSU further reflects a band other than target carrier bandwidth, and this causes interference.

### For an NCR Node

The NCR node is configured to extend a coverage range of a cell, including: receiving, amplifying, and forwarding a downlink signal from an upstream base station, so that strength of a signal arriving at UE is increased; and receiving, amplifying, and forwarding an uplink signal from the UE, so that strength of an uplink signal from the UE to the upstream base station is increased.

The NCR node may receive control from the upstream base station, that is, the base station may control a sending parameter of the NCR node, such as a switch and a transmit beam of the NCR node, to improve working efficiency of the NCR node and reduce interference. A network structure shown in FIG. 2 includes three network nodes, and an intermediate network node is an NCR node. The intermediate network node includes a mobile termination (MT) and a repeater unit (RU). The MT is also referred to as a mobile termination module, and the repeater unit is also referred to as an NCR forwarding (NCR-FWD) unit. It is possible that the NCR node includes only one of the MT or the RU. The MT may establish a connection to an upstream base station. The MT exchanges control signaling with the NCR node, so that the base station may indicate a sending or receiving related parameter of the MT of the NCR node, or indicate a sending or receiving related parameter of the RU of the NCR node.

Similar to the RIS node, the NCR node is connected to the base station and controlled by the base station, that is, the base station sends control information to the NCR node by using the MT of the NCR node, so as to control uplink/downlink power or amplification times, a beam parameter, or an uplink/downlink configuration of a Radio Frequency (RF) of the NCR node. Different from the RIS node, the RF unit of the NCR node is an active signal amplifier, and the received signal may be amplified and then sent.

In a related technology, after the NCR-MT enters a Radio Resource Control (RRC) inactive (INACTIVE) state, the NCR-FWD may continue forwarding based on a previously received forwarding configuration, and a main purpose is to save radio resources occupied to maintain a wireless connection between the NCR-MT and the gNB, so that more radio resources can be used for forwarding. However, after the NCR-MT is in the RRC_INACTIVE state, a wireless connection between the base station and the NCR-MT is released, and a corresponding radio resource is also released. The base station cannot send side control information to the NCR-MT to control forwarding behavior of the NCR-FWD, and consequently, forwarding performance of the NCR-FWD deteriorates. For example, the target signal cannot be forwarded or cannot be completely forwarded, the target signal is forwarded to a non-target area, and forwarding performance deteriorates due to an NCR exception.

In the embodiments of this application, an NCR node is used as an example. Before the NCR-MT is released to an RRC_INACTIVE state or an RRC idle (IDLE) state, that is, when the NCR-MT is in an RRC connected state, first forwarding configuration information is received from a network side device, where the first forwarding configuration information may be used to configure forwarding behavior of the NCR-FWD in a period in which the NCR-MT is in the RRC_INACTIVE state or the RRC_IDLE state. In this way, after the NCR-MT is released to the RRC_INACTIVE state or the RRC_IDLE state, the NCR-FWD may perform forwarding based on the first forwarding configuration information.

A forwarding control method, an information transmission method, a forwarding control apparatus, an information transmission apparatus, a layer-1 forwarding node, and a network side device provided in the embodiments of this application are described in detail below with reference to the accompanying drawings based on specific embodiments and application scenarios thereof.

Referring to FIG. 3, a forwarding control method provided in an embodiment of this application may be performed by a layer-1 forwarding node. For ease of description, in this embodiment of this application, that the layer-1 forwarding node is an NCR node is used as an example for description, and a specific type of the layer-1 forwarding node is not limited herein. The NCR node may include a mobile termination module (NCR-MT) and a forwarding unit (NCR-FWD). The NCR-MT is configured to establish a wireless connection to an upstream base station. The base station exchanges control signaling with an NCR node by using the NCR-MT, and may indicate a sending or receiving related parameter of the NCR-MT, or indicate a sending or receiving related parameter of the NCR-FWD.

As shown in FIG. 3, the forwarding control method provided in this embodiment of this application may include the following steps.

Step 301: A layer-1 forwarding node receives first forwarding configuration information from a network side device when a mobile termination module MT of the layer-1 forwarding node is in a radio resource control RRC connected state.

In an implementation, that the layer-1 forwarding node receives the first forwarding configuration information from the network side device may be that an NCR-MT receives the first forwarding configuration information from a base station.

In an implementation, the NCR-MT may obtain, in the RRC connected state, carried first forwarding configuration information from any configuration message received from the network side device.

In another implementation, that a layer-1 forwarding node receives first forwarding configuration information from a network side device when an MT of the layer-1 forwarding node is in an RRC connected state includes:
receiving a release message by using the MT of the layer-1 forwarding node when the MT of the layer-1 forwarding node is in the RRC connected state, where the release message carries the first forwarding configuration information, and the release message is used to release the MT of the layer-1 forwarding node to the first state.

In this way, the NCR-MT may receive the release message from the network side device, to release the NCR-MT to an RRC inactive state or an RRC idle state based on the release message. In this case, the first forwarding configuration information may be carried in the release message. In this way, signaling overheads can be reduced compared with a manner of transmitting the first forwarding configuration information by using another configuration message.

Step 302: The layer-1 forwarding node performs forwarding based on the first forwarding configuration information when the MT of the layer-1 forwarding node enters a first state, where the first state includes an RRC idle state or an RRC inactive state.

In an implementation, that an NCR node performs forwarding based on the first forwarding configuration information when the NCR-MT enters the first state may be: an NCR-FWD performs forwarding based on the first forwarding configuration information when the NCR-MT enters the first state.

In an optional implementation, forwarding behavior of the layer-1 forwarding node includes at least one of the following:
enabling uplink forwarding or stopping uplink forwarding or continuing uplink forwarding, enabling downlink forwarding or stopping downlink forwarding or continuing uplink forwarding, performing forwarding in a period of time, beam parameter configuration for forwarding, uplink configuration for forwarding, or downlink configuration for forwarding.

In an implementation, continuing uplink forwarding may indicate that uplink forwarding of the NCR-FWD is enabled when the NCR-MT is in the RRC connected state, and in this case, after the NCR-MT is released to the RRC idle state or the RRC inactive state, uplink forwarding of the NCR-FWD may be continued.

In an implementation, continuing downlink forwarding may indicate that downlink forwarding of the NCR-FWD is enabled when the NCR-MT is in the RRC connected state, and in this case, after the NCR-MT is released to the RRC idle state or the RRC inactive state, downlink forwarding of the NCR-FWD may be continued.

In an implementation, beam parameter configuration for forwarding may include configuration information of parameters such as an angle and power of a beam used for forwarding.

In an implementation, the first forwarding configuration information may be a semi-static forwarding configuration. In this way, when the NCR-MT is in the RRC inactive state or the RRC idle state, the NCR-FWD may perform forwarding based on the semi-static forwarding configuration.

In an implementation, the first forwarding configuration information may be configured in a resource or a channel that can be used in a period in which the NCR-MT is in the RRC inactive state or the RRC idle state. In this way, the NCR-MT may receive side control information based on the resource or the channel in the period in which the NCR-MT is in the RRC inactive state or the RRC idle state, to control forwarding behavior of the NCR-FWD. The side control information is used to control the forwarding behavior of the NCR-FWD. For example, the side control information includes beam information or forwarding on/off information used for uplink/downlink forwarding.

In some embodiments, the forwarding on/off information may instruct a forwarding unit to perform at least one of the following:
enabling or disabling uplink forwarding;
enabling or disabling downlink forwarding; or
enabling or disabling forwarding behavior.

In an optional implementation, the first forwarding configuration information includes first configuration information used to configure a radio resource or a physical channel; and
that the layer-1 forwarding node performs forwarding based on the first forwarding configuration information when the MT of the layer-1 forwarding node enters a first state includes:
when the MT of the layer-1 forwarding node enters the first state, receiving side control information based on a radio resource or a physical channel that is configured by using the first configuration information; and
performing, by the layer-1 forwarding node, forwarding based on the side control information.

After the NCR-MT is released to the RRC inactive state or the RRC idle state, a radio resource or a physical channel configured by the first configuration information is not released. In this way, after the NCR-MT is released to the RRC inactive state or the RRC idle state, the side control information sent by the base station may still be received based on the radio resource or the physical channel.

In an implementation, the first configuration information includes at least one of the following:
first information or second information, where the first information includes search space of first Downlink Control Information (DCI), a format configuration of the first DCI, and a Radio Network Temporary Identifier (RNTI) configuration used for sending the first DCI, and the first DCI is DCI used by the MT of the layer-1 forwarding node to receive the side control information; and the second information includes a template parameter for receiving second DCI, where the template parameter for receiving the second DCI is used to indicate a location at which the layer-1 forwarding node receives the second DCI in the first state, and the second DCI is DCI used by the MT of the layer-1 forwarding node to receive the side control information in the first state;
a semi-static Physical Downlink Shared Channel (PDSCH) resource configuration used to receive the side control information; or
a semi-static Physical Uplink Shared Channel (PUSCH) resource configuration used to send information to the network side device.

Option 1: The first DCI may be DCI used when the NCR-MT is in the RRC connected state. In other words, DCI used after the NCR-MT is released to the RRC inactive state or the RRC idle state is the same as DCI used when the NCR-MT is in the RRC connected state in terms of search space, a format configuration, and an RNTI configuration.

Option 2: The second DCI may be DCI dedicated to the NCR-MT in the RRC inactive state or the RRC idle state. In some embodiments, the location of receiving the second DCI may be a time domain location or a frequency domain location of receiving the second DCI.

Option 3: A PDSCH resource that is available after the NCR-MT is released to the RRC inactive state or the RRC idle state may be configured based on a semi-static PDSCH resource configuration, so that the side control information may be received based on the PDSCH resource.

Option 4: A PUSCH resource that is available after the NCR-MT is released to the RRC inactive state or the RRC idle state may be configured based on a semi-static PUSCH resource configuration. In this way, the NCR-MT in the RRC inactive state or the RRC idle state may send reporting information or feedback information to the base station based on the PUSCH resource. The reporting information may report an exception situation of the layer-1 forwarding node, and the feedback information may include feedback information of the opposite side control information.

It should be noted that, when the NCR-MT is released to the RRC inactive state or the RRC idle state, a resource pool of radio resources configured by the first configuration information is not released. In this way, after the NCR-MT is released to the RRC inactive state or the RRC idle state, the NCR-MT may receive the side control information by using the resource.

In this implementation, when the NCR-MT is in the RRC connected state, a radio resource or a physical channel that can be used to receive the side control information in the RRC inactive state or the RRC idle state may be configured by using the first forwarding configuration information. In this way, after the NCR-MT is released to the RRC inactive state or the RRC idle state, the side control information sent by the base station may be received based on the radio resource or the physical channel, so as to control forwarding behavior of the NCR-FWD.

In an optional implementation, the first forwarding configuration information includes information about a semi-static forwarding configuration; and
that the layer-1 forwarding node performs forwarding based on the first forwarding configuration information when the MT of the layer-1 forwarding node enters a first state includes:
the layer-1 forwarding node performs forwarding based on the semi-static forwarding configuration when the MT of the layer-1 forwarding node enters the first state.

For example, after the NCR-MT enters the RRC inactive state or the RRC idle state, the NCR-FWD performs forwarding based on the semi-static forwarding configuration.

In an optional implementation, the first forwarding configuration information includes first indication information, and the first indication information is used to instruct the layer-1 forwarding node to continue to perform forwarding or stop performing forwarding based on a received forwarding configuration after the MT of the layer-1 forwarding node enters the first state.

For example, after the NCR-MT enters the RRC inactive state or the RRC idle state, the NCR-FWD continues to perform forwarding or stops performing forwarding based on a forwarding configuration received by the NCR-MT.

In an implementation, an indication field of the first indication information may be added to the first forwarding configuration information in a protocol-defined manner. In this way, after the NCR-MT is released to the RRC inactive state or the RRC idle state, the first indication information may be used to instruct the NCR-FWD to continue to perform forwarding or stop performing forwarding based on the received forwarding configuration.

In an implementation, the semi-static forwarding configuration may be flexibly controlled to be activated or deactivated by using DCI. In this case, the first forwarding configuration information may include semi-static forwarding configuration information in an active state. In some embodiments, the method further includes:
the network side device sends a third message to the layer-1 forwarding node, where the third message is used to activate or deactivate the semi-static forwarding configuration.

In an implementation, that the network side device sends a third message to the layer-1 forwarding node may be: the base station sends the third message to the NCR-MT.

In an implementation, the third message is transmitted by using a radio resource or a physical channel configured by using the first configuration information, and the first forwarding configuration information includes the first configuration information. In some embodiments, the third message may be transmitted by using another resource or channel that is not released after the NCR-MT is released to the RRC inactive state or the RRC idle state, which is not exhaustive herein.

In an implementation, a quantity of transmission times of the third message is greater than or equal to 1. In this way, transmission reliability of the third message can be increased.

In an implementation, the method further includes:
the layer-1 forwarding node does not send a response message of the third message.

In an implementation, it may be agreed upon in a communication protocol that when the NCR-MT is in the RRC-INACTIVE/IDLE state, the NCR-MT does not send a corresponding response message to the base station after receiving an activation/deactivation message of the semi-static forwarding configuration.

That the layer-1 forwarding node does not send the response message of the third message may be: The layer-1 forwarding node activates or deactivates the semi-static forwarding configuration based on the received third message, but does not generate the response message of the third message; or the layer-1 forwarding node activates or deactivates the semi-static forwarding configuration based on the received third message, and generates a response message indicating whether the semi-static forwarding configuration is successfully activated or deactivated, but does not send the response message to the network side device.

In this implementation, an uplink time-frequency resource used to feed back the response message of the third message may not be reserved for the NCR-MT.

In another implementation, the semi-static forwarding configuration may be in an active state by default during configuration. In this way, the first forwarding configuration information may include information about semi-static forwarding configuration configured by the NCR node.

In an implementation, the semi-static forwarding configuration is configured to configure at least one of the following:
a length of a forwarding window, a time offset of a forwarding window, a time periodicity of occurrence of a forwarding window, or forwarding beam indication information; where
when the semi-static forwarding configuration is activated, the layer-1 forwarding node performs forwarding in a forwarding window determined based on the semi-static forwarding configuration.

The NCR-FWD is configured to perform forwarding in each forwarding window.

In an implementation, the semi-static forwarding configuration may include any forwarding parameter required for performing forwarding by the NCR-FWD, for example, transmit power or received signal strength.

In an implementation, the forwarding beam indication information may indicate beam information used when the NCR-FWD performs forwarding, such as a beam identifier.

In some embodiments, the semi-static forwarding configuration includes at least one of the following:
a first semi-static forwarding configuration received when the MT of the layer-1 forwarding node enters the first state;
a second semi-static forwarding configuration activated when the MT of the layer-1 forwarding node is in the first state;
a semi-static forwarding configuration activated when the MT of the layer-1 forwarding node is in the RRC connected state;
a semi-static forwarding configuration that is activated when the MT of the layer-1 forwarding node is in the RRC connected state and that is not instructed by fourth indication information to be deactivated or released, where a release message carries the fourth indication information;
a third semi-static forwarding configuration that a first message received when the MT of the layer-1 forwarding node is in the RRC connected state instructs to reserve in the first state, where the first message is used to configure a semi-static forwarding configuration in the RRC connected state, and the semi-static forwarding configuration in the RRC connected state includes the third semi-static forwarding configuration; or
a fourth semi-static forwarding configuration that is indicated in a second message received when the MT of the layer-1 forwarding node is in the RRC connected state and that keeps active in the first state, where the second message is used to configure a semi-static forwarding configuration that is activated for the layer-1 forwarding node when the MT of the layer-1 forwarding node is in the RRC connected state, and the semi-static forwarding configuration that is activated for the layer-1 forwarding node when the MT of the layer-1 forwarding node is in the RRC connected state includes the fourth semi-static forwarding configuration.

In an implementation, when the NCR-MT is in the RRC inactive state or the RRC idle state, the first semi-static forwarding configuration may be received by using a radio resource or a physical channel that is configured in the first configuration information and that can be used in the RRC inactive state or the RRC idle state, or by using another resource or channel that is available when the NCR-MT is in the RRC inactive state or the RRC idle state.

In an implementation, when the NCR-MT is in the RRC inactive state or the RRC idle state, the NCR-MT may receive an activation message by using a radio resource or a physical channel that is configured in the first configuration information and that can be used in the RRC inactive state or the RRC idle state, to activate a second semi-static forwarding configuration.

It should be noted that a semi-static forwarding configuration that has been configured for the NCR-MT in the RRC connected state may be deactivated or released when the NCR-MT is released to the RRC inactive state or the RRC idle state. For example, if the semi-static forwarding configuration that has been configured for the NCR-MT in the RRC connected state is activated, the semi-static forwarding configuration may be deactivated when the NCR-MT is released to the RRC inactive state or the RRC idle state; and if the semi-static forwarding configuration that has been configured for the NCR-MT in the RRC connected state is not activated, the semi-static forwarding configuration may be released when the NCR-MT is released to the RRC inactive state or the RRC idle state.

In an implementation, the semi-static forwarding configuration activated for the NCR-MT in the RRC connected state may be reserved, that is, the semi-static forwarding configuration activated in the RRC connected state is not activated or released, so that after the NCR-MT is released to the RRC inactive state or the RRC idle state, the NCR-FWD may perform forwarding based on the reserved semi-static forwarding configuration.

In an implementation, when the NCR-MT is in the RRC connected state, the semi-static forwarding configuration may be activated. When the network side device sends a release message to the NCR-MT to release the NCR-MT to the RRC inactive state or the RRC idle state, the release message may carry the fourth indication information, to instruct to deactivate or release the semi-static forwarding configuration that has been activated in the RRC connected state. In this way, a remaining semi-static forwarding configuration that is not activated or not released may be continued to be used after the NCR-MT is released to the RRC inactive state or the RRC idle state.

In some embodiments, when the release message carries the fourth indication information, the method further includes:
when the MT of the layer-1 forwarding node enters the first state, the layer-1 forwarding node releases a semi-static forwarding configuration that the fourth indication information instructs to release, or deactivates a semi-static forwarding configuration that the fourth indication information instructs to deactivate.

In an implementation, when the semi-static forwarding configuration indicated by the fourth indication information is in an active state, the NCR-MT may deactivate the semi-static forwarding configuration when entering the RRC inactive state or the RRC idle state.

In an implementation, when the semi-static forwarding configuration indicated by the fourth indication information is in an inactive state, the NCR-MT may release the semi-static forwarding configuration when entering the RRC inactive state or the RRC idle state.

In an implementation, when the NCR-MT is in the RRC connected state, the network side device may send the first message to the NCR-MT to configure a semi-static forwarding configuration used by the NCR-MT in the RRC connected state. In this case, the first message may further carry indication information used to indicate a third semi-static forwarding configuration reserved in the first state, so that the NCR-MT continues to use the reserved third semi-static forwarding configuration when being released to the RRC inactive state or the RRC idle state.

In some embodiments, when the MT of the layer-1 forwarding node receives the first message in the RRC connected state, the method further includes:
when the MT of the layer-1 forwarding node enters the first state, the layer-1 forwarding node releases or deactivates a fifth semi-static forwarding configuration configured in the first message, where the fifth semi-static forwarding configuration and the third semi-static forwarding configuration are different semi-static forwarding configurations configured in the first message.

For example, when the fifth semi-static forwarding configuration is in an inactive state, the NCR-MT may release the fifth semi-static forwarding configuration when entering the RRC inactive state or the RRC idle state; and when the fifth semi-static forwarding configuration is in an active state, the NCR-MT may deactivate the fifth semi-static forwarding configuration when entering the RRC inactive state or the RRC idle state.

In an implementation, when the NCR-MT is in the RRC connected state, the network side device may send the second message to the NCR-MT to activate a semi-static forwarding configuration used by the NCR node when the NCR-MT is in the RRC connected state. In this case, the second message may further carry indication information used to indicate the fourth semi-static forwarding configuration that keeps in an active state in the first state, so that when the NCR-MT is released to the RRC inactive state or the RRC idle state, the NCR node can continue to use the fourth semi-static forwarding configuration that keeps in the active state.

In some embodiments, when the MT of the layer-1 forwarding node receives the second message in the RRC connected state, the method further includes:
when the MT of the layer-1 forwarding node enters the first state, the layer-1 forwarding node releases or deactivates a sixth semi-static forwarding configuration configured in the second message, where the sixth semi-static forwarding configuration and the fourth semi-static forwarding configuration are different semi-static forwarding configurations configured in the second message.

In this implementation, when the NCR-MT is released to the RRC inactive state or the RRC idle state, a remaining semi-static forwarding configuration may be deactivated or released for a sixth semi-static forwarding configuration that is in the semi-static forwarding configuration activated when the NCR-MT is in the RRC connected state and that is not indicated by the second message.

In an optional implementation, when the release message carries the first forwarding configuration information, the release message carries second indication information, the second indication information instructs the MT of the layer-1 forwarding node to reserve a first radio resource, and the first radio resource includes all or a part of radio resources allocated by the MT of the layer-1 forwarding node when in the RRC connected state; and
that the layer-1 forwarding node performs forwarding based on the first forwarding configuration information when the MT of the layer-1 forwarding node enters a first state includes:
receiving the side control information based on the first radio resource when the MT of the layer-1 forwarding node enters the first state; and
performing, by the layer-1 forwarding node, forwarding based on the side control information.

In an implementation, the NCR-MT in the RRC connected state is configured with radio resources between the NCR-MT and the base station. After the NCR-MT is released to the RRC inactive state or the RRC idle state, a part or all of the radio resources may be reserved, to continue to use the unreleased resource to transmit the side control information.

In this implementation, based on the reserved radio resource, the NCR-MT may receive the side control information from the network side device in the RRC inactive state or the RRC idle state, to control the forwarding behavior of the NCR-FWD.

In an optional implementation, when the release message carries the first forwarding configuration information, the release message carries third indication information, the third indication information instructs the MT of the layer-1 forwarding node to release a second radio resource, and the second radio resource includes a part of radio resources allocated when the MT of the layer-1 forwarding node is in the RRC connected state; and
that the layer-1 forwarding node performs forwarding based on the first forwarding configuration information when the MT of the layer-1 forwarding node enters a first state includes:
receiving the side control information based on a third radio resource when the MT of the layer-1 forwarding node enters the first state, where the third radio resource is a radio resource that is allocated by the MT of the layer-1 forwarding node when in the RRC connected state other than the second radio resource; and
performing, by the layer-1 forwarding node, forwarding based on the side control information.

In this implementation, the third indication information is similar to the second indication information, except that the second indication information indicates that all or a part of radio resources between the NCR-MT and the base station that are configured for the NCR-MT in the RRC connected state when the NCR-MT is released to the RRC inactive state and the RRC idle state, and the third indication information indicates that a part of radio resources between the NCR-MT and the base station that are configured for the NCR-MT in the RRC connected state when the NCR-MT is released to the RRC inactive state and the RRC idle state. Naturally, remaining radio resources that are not released are reserved. In this way, similarly, based on the reserved radio resource, the NCR-MT may receive the side control information from the network side device in the RRC inactive state or the RRC idle state, to control the forwarding behavior of the NCR-FWD.

In this embodiment of this application, a layer-1 forwarding node receives first forwarding configuration information from a network side device when an MT of the layer-1 forwarding node is in a radio resource control RRC connected state, and the layer-1 forwarding node performs forwarding based on the first forwarding configuration information when the MT of the layer-1 forwarding node enters a first state, where the first state includes an RRC idle state or an RRC inactive state. In this way, the forwarding behavior of the layer-1 forwarding node when the MT of the layer-1 forwarding node is in the RRC idle state or the RRC inactive state can be controlled based on the first forwarding configuration information, so that forwarding performance of the layer-1 forwarding node can be improved.

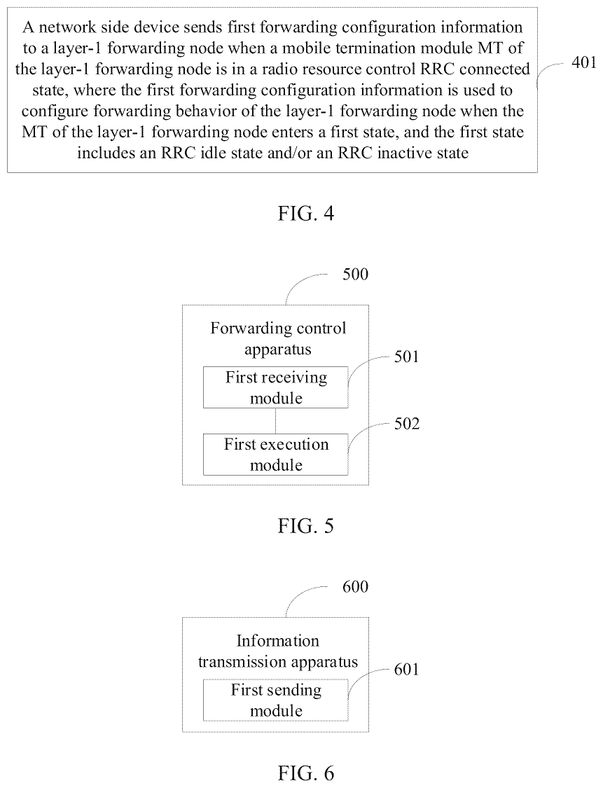

Referring to FIG. 4, an information transmission method provided in an embodiment of this application may be performed by a network side device. For ease of description, in this embodiment of this application, that the network side device is a base station is used as an example for description. A specific type of the network side device is not limited herein.

As shown in FIG. 4, the information transmission method provided in this embodiment of this application may include the following steps.

Step 401: A network side device sends first forwarding configuration information to a layer-1 forwarding node when a mobile termination module MT of the layer-1 forwarding node is in a radio resource control RRC connected state, where the first forwarding configuration information is used to configure forwarding behavior of the layer-1 forwarding node when the MT of the layer-1 forwarding node enters a first state, and the first state includes an RRC idle state or an RRC inactive state.

It should be noted that meanings and functions of the layer-1 forwarding node, the mobile termination module, the first forwarding configuration information, and the first state are the same as meanings and functions of the layer-1 forwarding node, the first forwarding configuration information, and the first state in the method embodiment shown in FIG. 3. Details are not described herein again.

In the information transmission method provided in this embodiment of this application, steps performed by the network side device are corresponding to the steps of the forwarding control method performed by the layer-1 forwarding node in the method embodiment shown in FIG. 3, and an effect similar to that in the method embodiment shown in FIG. 3 can be obtained. To avoid repetition, details are not described herein again.

In an optional implementation, the first forwarding configuration information includes first configuration information used to configure a radio resource or a physical channel; and
the radio resource or the physical channel is used by the MT of the layer-1 forwarding node to receive side control information in the first state, and the side control information is used to control the forwarding behavior of the layer-1 forwarding node.

In an optional implementation, the first forwarding configuration information includes information about a semi-static forwarding configuration, and the semi-static forwarding configuration is used to configure forwarding behavior of the layer-1 forwarding node after the MT of the layer-1 forwarding node enters the first state.

In an optional implementation, the first forwarding configuration information includes first indication information, and the first indication information is used to instruct the layer-1 forwarding node to continue to perform forwarding or stop performing forwarding based on a received forwarding configuration after the MT of the layer-1 forwarding node enters the first state.

In an optional implementation, the first configuration information includes at least one of the following:
first information or second information, where the first information includes search space of first downlink control information DCI, a format configuration of the first DCI, and an RNTI configuration used for sending the first DCI, and the first DCI is DCI used by the MT of the layer-1 forwarding node to receive the side control information; and the second information includes a template parameter for receiving second DCI, where the template parameter for receiving the second DCI is used to indicate a location at which the MT of the layer-1 forwarding node receives the second DCI in the first state, and the second DCI is DCI used by the MT of the layer-1 forwarding node to receive the side control information in the first state;
a semi-static physical downlink shared channel PDSCH resource configuration used to receive the side control information; or
a semi-static physical uplink shared channel PUSCH resource configuration used to send information to the network side device.

In an optional implementation, that a network side device sends first forwarding configuration information to a layer-1 forwarding node includes:
the network side device sends a release message to the MT of the layer-1 forwarding node, where the release message carries the first forwarding configuration information, and the release message is used to release the MT of the layer-1 forwarding node to the first state.

In an optional implementation, the release message carries second indication information, the second indication information instructs the MT of the layer-1 forwarding node to reserve a first radio resource, and the first radio resource includes all or a part of radio resources allocated by the MT of the layer-1 forwarding node when in the RRC connected state; and
the method further includes:
when the MT of the layer-1 forwarding node is in the first state, the network side device sends the side control information to the MT of the layer-1 forwarding node by using the first radio resource.

In an optional implementation, the release message carries third indication information, the third indication information instructs the MT of the layer-1 forwarding node to release a second radio resource, and the second radio resource includes a part of radio resources allocated when the MT of the layer-1 forwarding node is in the RRC connected state;
the method further includes:
when the MT of the layer-1 forwarding node is in the first state, the network side device sends the side control information to the MT of the layer-1 forwarding node by using a third radio resource, where the third radio resource is a radio resource that is allocated by the MT of the layer-1 forwarding node when in the RRC connected state other than the second radio resource.

In an optional implementation, the semi-static forwarding configuration is used to configure at least one of the following:
a length of a forwarding window, a time offset of a forwarding window, a time periodicity of occurrence of a forwarding window, or forwarding beam indication information; where
when the semi-static forwarding configuration is activated, the layer-1 forwarding node performs forwarding in a forwarding window determined based on the semi-static forwarding configuration.

In an optional implementation, that a network side device sends first forwarding configuration information to a layer-1 forwarding node includes:
the network side device sends a release message to the MT of the layer-1 forwarding node, where the release message carries the semi-static forwarding configuration, the release message is used to release the MT of the layer-1 forwarding node to the first state, and the first forwarding configuration information includes the semi-static forwarding configuration.

In an optional implementation, the semi-static forwarding configuration includes at least one of the following:
a first semi-static forwarding configuration received when the MT of the layer-1 forwarding node enters the first state;
a second semi-static forwarding configuration activated when the MT of the layer-1 forwarding node is in the first state;
a semi-static forwarding configuration activated when the MT of the layer-1 forwarding node is in the RRC connected state;
a semi-static forwarding configuration that is activated when the MT of the layer-1 forwarding node is in the RRC connected state and that is not instructed by fourth indication information to be deactivated or released, where a release message carries the fourth indication information;
a third semi-static forwarding configuration that a first message received when the MT of the layer-1 forwarding node is in the RRC connected state instructs to reserve in the first state, where the first message is used to configure a semi-static forwarding configuration in the RRC connected state, and the semi-static forwarding configuration in the RRC connected state includes the third semi-static forwarding configuration; or
a fourth semi-static forwarding configuration that is indicated in a second message received when the MT of the layer-1 forwarding node is in the RRC connected state and that keeps active in the first state, where the second message is used to configure a semi-static forwarding configuration that is activated for the layer-1 forwarding node when the MT of the layer-1 forwarding node is in the RRC connected state, and the semi-static forwarding configuration that is activated for the layer-1 forwarding node when the MT of the layer-1 forwarding node is in the RRC connected state includes the fourth semi-static forwarding configuration.

In an optional implementation, the method further includes:
the network side device sends a third message to the layer-1 forwarding node, where the third message is used to activate or deactivate the semi-static forwarding configuration.

In an optional implementation, the third message is transmitted by using a radio resource or a physical channel configured by using the first configuration information, and the first forwarding configuration information includes the first configuration information.

In an optional implementation, a quantity of transmission times of the third message is greater than or equal to 1.

In this embodiment of this application, a network side device sends first forwarding configuration information to a layer-1 forwarding node in a radio resource control RRC connected state, so that after entering an RRC idle state or an RRC inactive state, the layer-1 forwarding node can control forwarding behavior of the layer-1 forwarding node based on the first forwarding configuration information. In this way, forwarding behavior in the RRC idle state or the RRC inactive state can be controlled based on the first forwarding configuration information, so that forwarding performance of the layer-1 forwarding node in the RRC idle state or the RRC inactive state can be improved.

The forwarding control method provided in the embodiments of this application may be performed by a forwarding control apparatus. In the embodiments of this application, the forwarding control apparatus provided in the embodiments of this application is described by using an example in which the forwarding control apparatus performs the forwarding control method.

The forwarding control apparatus provided in this embodiment of this application may be an apparatus in a layer-1 forwarding node. As shown in FIG. 5, a forwarding control apparatus 500 may include the following modules:
a first receiving module 501, configured to receive first forwarding configuration information from a network side device when a mobile termination module MT of the layer-1 forwarding node is in a radio resource control RRC connected state; and
a first execution module 502, configured to perform forwarding based on the first forwarding configuration information when the MT of the layer-1 forwarding node enters a first state, where the first state includes an RRC idle state or an RRC inactive state.

In some embodiments, the first forwarding configuration information includes first configuration information used to configure a radio resource or a physical channel; and
the first execution module 502 includes:
a first receiving unit, configured to: when the MT of the layer-1 forwarding node enters the first state, receive side control information based on a radio resource or a physical channel that is configured by using the first configuration information; and
a first forwarding unit, configured to perform forwarding based on the side control information.

In some embodiments, the first forwarding configuration information includes information about a semi-static forwarding configuration; and
the first execution module 502 is configured to:
perform forwarding based on the semi-static forwarding configuration when the MT of the layer-1 forwarding node enters the first state.

In some embodiments, the first forwarding configuration information includes first indication information, and the first indication information is used to instruct the layer-1 forwarding node to continue to perform forwarding or stop performing forwarding based on a received forwarding configuration after the MT in layer-1 forwarding node enters the first state.

In some embodiments, the first configuration information includes at least one of the following:
first information or second information, where the first information includes search space of first downlink control information DCI, a format configuration of the first DCI, and an RNTI configuration used for sending the first DCI, and the first DCI is DCI used by the MT of the layer-1 forwarding node to receive the side control information; and the second information includes a template parameter for receiving second DCI, where the template parameter for receiving the second DCI is used to indicate a location at which the MT of the layer-1 forwarding node receives the second DCI in the first state, and the second DCI is DCI used by the MT of the layer-1 forwarding node to receive the side control information in the first state;
a semi-static physical downlink shared channel PDSCH resource configuration used to receive the side control information; or
a semi-static physical uplink shared channel PUSCH resource configuration used to send information to the network side device.

In some embodiments, the first receiving module 501 is configured to:
receive a release message by using the MT of the layer-1 forwarding node when the MT of the layer-1 forwarding node is in the RRC connected state, where the release message carries the first forwarding configuration information, and the release message is used to release the MT of the layer-1 forwarding node to the first state.

In some embodiments, the release message carries second indication information, the second indication information instructs the MT of the layer-1 forwarding node to reserve a first radio resource, and the first radio resource includes all or a part of radio resources allocated by the MT of the layer-1 forwarding node when in the RRC connected state; and
the first execution module 502 includes:
a second receiving unit, configured to receive the side control information based on the first radio resource when the MT of the layer-1 forwarding node enters the first state; and
a second forwarding unit, configured to perform forwarding based on the side control information.

In some embodiments, the release message carries third indication information, the third indication information instructs the MT of the layer-1 forwarding node to release a second radio resource, and the second radio resource includes a part of radio resources allocated when the MT of the layer-1 forwarding node is in RRC connected state; and
the first execution module 502 includes:
a third receiving unit, configured to receive the side control information based on a third radio resource when the MT of the layer-1 forwarding node enters the first state, where the third radio resource is a radio resource that allocated by the MT of the layer-1 forwarding node when in the RRC connected state other than the second radio resource; and
a third forwarding unit, configured to perform forwarding based on the side control information.

In some embodiments, the semi-static forwarding configuration is used to configure at least one of the following:
a length of a forwarding window, a time offset of a forwarding window, a time periodicity of occurrence of a forwarding window, or forwarding beam indication information; where
when the semi-static forwarding configuration is activated, the layer-1 forwarding node performs forwarding in a forwarding window determined based on the semi-static forwarding configuration.

In some embodiments, the semi-static forwarding configuration includes at least one of the following:
a first semi-static forwarding configuration received when the MT of the layer-1 forwarding node enters the first state;
a second semi-static forwarding configuration activated when the MT of the layer-1 forwarding node is in the first state;
a semi-static forwarding configuration activated when the MT of the layer-1 forwarding node is in the RRC connected state;
a semi-static forwarding configuration that is activated when the MT of the layer-1 forwarding node is in the RRC connected state and that is not instructed by fourth indication information to be deactivated or released, where a release message carries the fourth indication information;
a third semi-static forwarding configuration that a first message received when the MT of the layer-1 forwarding node is in the RRC connected state instructs to reserve in the first state, where the first message is used to configure a semi-static forwarding configuration in the RRC connected state, and the semi-static forwarding configuration in the RRC connected state includes the third semi-static forwarding configuration; or
a fourth semi-static forwarding configuration that is indicated in a second message received when the MT of the layer-1 forwarding node is in the RRC connected state and that keeps active in the first state, where the second message is used to configure a semi-static forwarding configuration that is activated for the layer-1 forwarding node when the MT of the layer-1 forwarding node is in the RRC connected state, and the semi-static forwarding configuration that is activated for the layer-1 forwarding node when the MT of the layer-1 forwarding node is in the RRC connected state includes the fourth semi-static forwarding configuration.

In some embodiments, the forwarding control apparatus 500 further includes:
a second receiving module, configured to receive a third message from the network side device, where the third message is used to activate or deactivate the semi-static forwarding configuration.

In some embodiments, the third message is transmitted by using a radio resource or a physical channel configured by using the first configuration information, and the first forwarding configuration information includes the first configuration information.

In some embodiments, a transmission times of the third message is greater than or equal to 1.

In some embodiments, the forwarding control apparatus 500 further includes:
an execution module, configured to skip sending a response message of the third message.

In some embodiments, when the release message carries the fourth indication information, the forwarding control apparatus 500 further includes:
a first releasing module, configured to: when the MT of the layer-1 forwarding node enters the first state, release a semi-static forwarding configuration that the fourth indication information instructs to release, or deactivate a semi-static forwarding configuration that the fourth indication information instructs to deactivate.

In some embodiments, when the MT of the layer-1 forwarding node receives the first message in the RRC connected state, the forwarding control apparatus 500 further includes:
a second releasing module, configured to: when the MT of the layer-1 forwarding node enters the first state, release or deactivate a fifth semi-static forwarding configuration configured in the first message, where the fifth semi-static forwarding configuration and the third semi-static forwarding configuration are different semi-static forwarding configurations configured in the first message.

In some embodiments, when the MT of the layer-1 forwarding node receives the second message in the RRC connected state, the forwarding control apparatus 500 further includes:
a third releasing module, configured to: when the MT of the layer-1 forwarding node enters the first state, release or deactivate a sixth semi-static forwarding configuration configured in the second message, where the sixth semi-static forwarding configuration and the fourth semi-static forwarding configuration are different semi-static forwarding configurations configured in the second message.

In some embodiments, forwarding behavior of the layer-1 forwarding node includes at least one of the following:
enabling uplink forwarding or stopping uplink forwarding or continuing uplink forwarding, enabling downlink forwarding or stopping downlink forwarding or continuing uplink forwarding, performing forwarding in a period of time, beam parameter configuration for forwarding, uplink configuration for forwarding, or downlink configuration for forwarding.

The forwarding control apparatus in this embodiment of this application may be an electronic device, for example, an electronic device with an operating system, or may be a component in the electronic device, for example, an integrated circuit or a chip. The electronic device may be the layer-1 forwarding node. For example, the layer-1 forwarding node may include but is not limited to the types of layer-1 forwarding nodes 13 listed above.

The forwarding control apparatus provided in this embodiment of this application can implement the processes implemented in the method embodiment shown in FIG. 3, and achieve a same technical effect. To avoid repetition, details are not provided herein again.

An information transmission method provided in the embodiments of this application may be performed by an information transmission apparatus. In the embodiments of this application, that the information transmission apparatus performs the information transmission method is used as an example to describe the information transmission apparatus provided in the embodiments of this application.

An information transmission apparatus provided in an embodiment of this application may be an apparatus in a network side device. As shown in FIG. 6, an information transmission apparatus 600 may include the following module:
a first sending module 601, configured to send first forwarding configuration information to a layer-1 forwarding node when a mobile termination module MT of the layer-1 forwarding node is in a radio resource control RRC connected state, where the first forwarding configuration information is used to configure forwarding behavior of the layer-1 forwarding node when the MT of the layer-1 forwarding node enters a first state, and the first state includes an RRC idle state or an RRC inactive state.

In some embodiments, the first forwarding configuration information includes first configuration information used to configure a radio resource or a physical channel; and
the radio resource or the physical channel is used by the MT of the layer-1 forwarding node to receive side control information in the first state, and the side control information is used to control the forwarding behavior of the layer-1 forwarding node.

In some embodiments, the first forwarding configuration information includes information about a semi-static forwarding configuration, and the semi-static forwarding configuration is used to configure forwarding behavior of the layer-1 forwarding node after the MT of the layer-1 forwarding node enters the first state.

In some embodiments, the first forwarding configuration information includes first indication information, and the first indication information is used to instruct the layer-1 forwarding node to continue to perform forwarding or stop performing forwarding based on a received forwarding configuration after the MT in layer-1 forwarding node enters the first state.

In some embodiments, the first configuration information includes at least one of the following:
first information or second information, where the first information includes search space of first downlink control information DCI, a format configuration of the first DCI, and an RNTI configuration used for sending the first DCI, and the first DCI is DCI used by the MT of the layer-1 forwarding node to receive the side control information; and the second information includes a template parameter for receiving second DCI, where the template parameter for receiving the second DCI is used to indicate a location at which the MT of the layer-1 forwarding node receives the second DCI in the first state, and the second DCI is DCI used by the MT of the layer-1 forwarding node to receive the side control information in the first state;
a semi-static physical downlink shared channel PDSCH resource configuration used to receive the side control information; or
a semi-static physical uplink shared channel PUSCH resource configuration used to send information to the network side device.

In some embodiments, the first sending module 601 is configured to:
send a release message to the MT of the layer-1 forwarding node when the mobile termination module MT of the layer-1 forwarding node is in the radio resource control RRC connected state, where the release message carries the first forwarding configuration information, and the release message is used to release the MT of the layer-1 forwarding node to the first state.

In some embodiments, the release message carries second indication information, the second indication information instructs the MT of the layer-1 forwarding node to reserve a first radio resource, and the first radio resource includes all or a part of radio resources allocated by the MT of the layer-1 forwarding node when in RRC connected state; and
the information transmission apparatus 600 further includes:
a second sending module, configured to: when the MT of the layer-1 forwarding node is in the first state, send the side control information to the MT of the layer-1 forwarding node by using the first radio resource.

In some embodiments, the release message carries third indication information, the third indication information instructs the MT of the layer-1 forwarding node to release a second radio resource, and the second radio resource includes a part of radio resources allocated when the MT of the layer-1 forwarding node is in RRC connected state; and
the information transmission apparatus 600 further includes:
a third sending module, configured to: when the MT of the layer-1 forwarding node is in the first state, sends the side control information to the MT of the layer-1 forwarding node by using a third radio resource, where the third radio resource is a radio resource that is allocated by the MT of the layer-1 forwarding node when in the RRC connected state other than the second radio resource.

In some embodiments, the semi-static forwarding configuration is used to configure at least one of the following:
a length of a forwarding window, a time offset of a forwarding window, a time periodicity of occurrence of a forwarding window, or forwarding beam indication information; where
when the semi-static forwarding configuration is activated, the layer-1 forwarding node performs forwarding in a forwarding window determined based on the semi-static forwarding configuration.

In some embodiments, the first sending module 601 is configured to:
send a release message to the MT of the layer-1 forwarding node when the mobile termination module MT of the layer-1 forwarding node is in the radio resource control RRC connected state, where the release message carries a semi-static forwarding configuration, the release message is used to release the MT of the layer-1 forwarding node to the first state, and the first forwarding configuration information includes the semi-static forwarding configuration.

In some embodiments, the semi-static forwarding configuration includes at least one of the following:
a first semi-static forwarding configuration received when the MT of the layer-1 forwarding node enters the first state;
a second semi-static forwarding configuration activated when the MT of the layer-1 forwarding node is in the first state;
a semi-static forwarding configuration activated when the MT of the layer-1 forwarding node is in the RRC connected state;
a semi-static forwarding configuration that is activated when the MT of the layer-1 forwarding node is in the RRC connected state and that is not instructed by fourth indication information to be deactivated or released, where a release message carries the fourth indication information;
a third semi-static forwarding configuration that a first message received when the MT of the layer-1 forwarding node is in the RRC connected state instructs to reserve in the first state, where the first message is used to configure a semi-static forwarding configuration in the RRC connected state, and the semi-static forwarding configuration in the RRC connected state includes the third semi-static forwarding configuration; or
a fourth semi-static forwarding configuration that is indicated in a second message received when the MT of the layer-1 forwarding node is in the RRC connected state and that keeps active in the first state, where the second message is used to configure a semi-static forwarding configuration that is activated for the layer-1 forwarding node when the MT of the layer-1 forwarding node is in the RRC connected state, and the semi-static forwarding configuration that is activated for the layer-1 forwarding node when the MT of the layer-1 forwarding node is in the RRC connected state includes the fourth semi-static forwarding configuration.

In some embodiments, the information transmission apparatus 600 further includes:
a fourth sending module, configured to send a third message to the layer-1 forwarding node, where the third message is used to activate or deactivate the semi-static forwarding configuration.

In some embodiments, the third message is transmitted by using a radio resource or a physical channel configured by using the first configuration information, and the first forwarding configuration information includes the first configuration information.

In some embodiments, a transmission times of the third message is greater than or equal to 1.

The information transmission apparatus in this embodiment of this application may be an electronic device, for example, an electronic device with an operating system, or may be a component in the electronic device, for example, an integrated circuit or a chip. The electronic device may be a network side device. For example, the network side device may include but is not limited to the types of network side devices 12 listed above.

The information transmission apparatus provided in this embodiment of this application can implement the processes implemented in the method embodiment shown in FIG. 4, and achieve a same technical effect. To avoid repetition, details are not provided herein again.

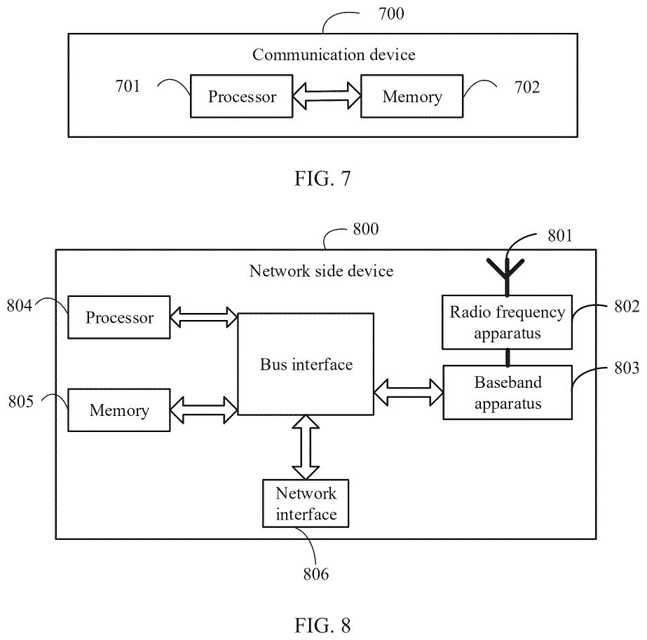

As shown in FIG. 7, an embodiment of this application further provides a communication device 700, including a processor 701 and a memory 702, and the memory 702 stores a program or instructions that are capable of running on the processor 701. For example, when the communication device 700 is a layer-1 forwarding node, when the program or the instruction is executed by the processor 701, the steps of the foregoing embodiment of the forwarding control method are implemented, and a same technical effect can be achieved. When the communication device 700 is a network side device, when the program or the instructions are executed by the processor 701, the steps of the foregoing embodiment of the information transmission method are implemented, and a same technical effect can be achieved. To avoid repetition, details are not described herein again.

An embodiment of this application further provides a layer-1 forwarding node, including a processor and a communication interface. The communication interface is configured to: receive first forwarding configuration information from a network side device when a mobile termination module MT of the layer-1 forwarding node is in a radio resource control RRC connected state; and perform forwarding based on the first forwarding configuration information when the MT of the layer-1 forwarding node enters a first state, where the first state includes an RRC idle state or an RRC inactive state.

This embodiment of the layer-1 forwarding node is corresponding to the foregoing method embodiment on the layer-1 forwarding node side. Each implementation process and implementation of the foregoing method embodiment may be applicable to this embodiment of the layer-1 forwarding node, and a same technical effect can be achieved.

An embodiment of this application further provides a network side device, including a processor and a communication interface. The communication interface is configured to send first forwarding configuration information to a layer-1 forwarding node when a mobile termination module MT of the layer-1 forwarding node is in a radio resource control RRC connected state, where the first forwarding configuration information is used to configure forwarding behavior of the layer-1 forwarding node when the MT of the layer-1 forwarding node enters a first state, and the first state includes an RRC idle state or an RRC inactive state.

This embodiment of the network side device is corresponding to the foregoing method embodiment of the network side device. Each implementation process and implementation of the foregoing method embodiment may be applicable to this embodiment of the network side device, and a same technical effect can be achieved.

An embodiment of this application further provides a network side device. As shown in FIG. 8, the network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information through the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information through the antenna 801.

In the foregoing embodiment, the method performed by the network side device may be implemented in the baseband apparatus 803. The baseband apparatus 803 includes a baseband processor.

For example, the baseband apparatus 803 may include at least one baseband board. A plurality of chips are disposed on the baseband board. As shown in FIG. 8, one chip is, for example, a baseband processor, and is connected to the memory 805 by using a bus interface, to invoke a program in the memory 805 to perform the operations of the network device shown in the foregoing method embodiment.

The network side device may further include a network interface 806, and the interface is, for example, a Common Public Radio Interface (CPRI).

The network side device 800 in this embodiment of the present application further includes an instruction or a program that is stored in the memory 805 and that can be run on the processor 804. The processor 804 invokes the instruction or the program in the memory 805 to perform the method performed by the modules shown in FIG. 6, and a same technical effect is achieved. To avoid repetition, details are not described herein again.

An embodiment of this application further provides a readable storage medium. The readable storage medium stores a program or instructions. When the program or the instructions are executed by a processor, the processes of the method embodiment in FIG. 3 or FIG. 4 can be implemented, and a same technical effect can be achieved. To avoid repetition, details are not described herein.

The processor is the processor in the layer-1 forwarding node or the network side device described in the foregoing embodiment. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, and the processor is configured to run a program or instructions to implement the processes of the method embodiment shown in FIG. 3 or FIG. 4, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a non-volatile storage medium, and the computer program/program product is executed by at least one processor to implement the processes of the method embodiment shown in FIG. 3 or FIG. 4, and a same technical effect can be achieved. To avoid repetition, details are not described herein again.

An embodiment of this application further provides a communication system, including a layer-1 forwarding node and a network side device. The layer-1 forwarding node may be configured to perform the steps of the forwarding control method shown in FIG. 3, and the network side device may be configured to perform the steps of the information transmission method shown in FIG. 4.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product in addition to a necessary universal hardware platform or by hardware. The computer software product is stored in a storage medium (such as a ROM, a RAM, a magnetic disk, or an optical disc), and includes several instructions for instructing a terminal or a network side device to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms of implementations without departing from the purpose of this application and the protection scope of the claims, all of which fall within the protection of this application.

The invention claimed is:

1. A forwarding control method, comprising:
receiving, by a layer-1 forwarding node, first forwarding configuration information from a network side device when a mobile termination module (MT) of the layer-1 forwarding node is in a radio resource control (RRC) connected state; and
performing, by the layer-1 forwarding node, forwarding based on the first forwarding configuration information when the MT of the layer-1 forwarding node enters a first state, wherein the first state comprises an RRC idle state or an RRC inactive state.

2. The method according to claim 1, wherein the first forwarding configuration information comprises first configuration information for configuring a radio resource or a physical channel; and
the performing, by the layer-1 forwarding node, forwarding based on the first forwarding configuration information when the MT of the layer-1 forwarding node enters a first state comprises:
when the MT of the layer-1 forwarding node enters the first state, receiving side control information based on a radio resource or a physical channel that is configured by using the first configuration information; and
performing, by the layer-1 forwarding node, forwarding based on the side control information.

3. The method according to claim 1, wherein the first forwarding configuration information comprises information about a semi-static forwarding configuration; and
the performing, by the layer-1 forwarding node, forwarding based on the first forwarding configuration information when the MT of the layer-1 forwarding node enters a first state comprises:
performing, by the layer-1 forwarding node, forwarding based on the semi-static forwarding configuration when the MT of the layer-1 forwarding node enters the first state.

4. The method according to claim 1, wherein the first forwarding configuration information comprises first indication information, and the first indication information is used to instruct the layer-1 forwarding node to continue performing forwarding or stop performing forwarding based on a received forwarding configuration after the MT of the layer-1 forwarding node enters the first state.

5. The method according to claim 2, wherein the first configuration information comprises at least one of the following:
first information or second information, wherein the first information comprises search space of first downlink control information (DCI), a format configuration of the first DCI, and a Radio Network Temporary Identifier (RNTI) configuration used for sending the first DCI, and the first DCI is DCI used by the MT of the layer-1 forwarding node to receive the side control information;
and the second information comprises a template parameter for receiving second DCI, wherein the template parameter for receiving the second DCI is used to indicate a location at which the MT of the layer-1 forwarding node receives the second DCI in the first state, and the second DCI is DCI used by the MT of the layer-1 forwarding node to receive the side control information in the first state;
a semi-static physical downlink shared channel (PDSCH) resource configuration used to receive the side control information; or
a semi-static physical uplink shared channel (PUSCH) resource configuration used to send information to the network side device.

6. The method according to claim 1, wherein the receiving, by a layer-1 forwarding node, first forwarding configuration information from a network side device when an MT of the layer-1 forwarding node is in an RRC connected state comprises:
receiving a release message by using the MT of the layer-1 forwarding node when the MT of the layer-1 forwarding node is in the RRC connected state, wherein the release message carries the first forwarding configuration information, and the release message is used to release the MT of the layer-1 forwarding node to the first state.

7. The method according to claim 6, wherein the release message carries second indication information, the second indication information instructs the MT of the layer-1 forwarding node to reserve a first radio resource, and the first radio resource comprises all or a part of radio resources allocated by the MT of the layer-1 forwarding node when in the RRC connected state; and
the performing, by the layer-1 forwarding node, forwarding based on the first forwarding configuration information when the MT of the layer-1 forwarding node enters a first state comprises:
receiving the side control information based on the first radio resource when the MT of the layer-1 forwarding node enters the first state; and
performing, by the layer-1 forwarding node, forwarding based on the side control information.

8. The method according to claim 6, wherein the release message carries third indication information, the third indication information instructs the MT of the layer-1 forwarding node to release a second radio resource, and the second radio resource comprises a part of radio resources allocated by the MT of the layer-1 forwarding node when in the RRC connected state; and
the performing, by the layer-1 forwarding node, forwarding based on the first forwarding configuration information when the MT of the layer-1 forwarding node enters a first state comprises:
receiving the side control information based on a third radio resource when the MT of the layer-1 forwarding node enters the first state, wherein the third radio resource is a radio resource that is allocated by the MT of the layer-1 forwarding node when in the RRC connected state other than the second radio resource; and
performing, by the layer-1 forwarding node, forwarding based on the side control information.

9. The method according to claim 3, wherein the semi-static forwarding configuration is used to configure at least one of the following:
a length of a forwarding window, a time offset of a forwarding window, a time periodicity of occurrence of a forwarding window, or forwarding beam indication information, wherein
when the semi-static forwarding configuration is activated, the layer-1 forwarding node performs forwarding in a forwarding window determined based on the semi-static forwarding configuration.

10. The method according to claim 3, wherein the semi-static forwarding configuration comprises at least one of the following:
a first semi-static forwarding configuration received when the MT of the layer-1 forwarding node enters the first state;
a second semi-static forwarding configuration activated when the MT of the layer-1 forwarding node is in the first state;
a semi-static forwarding configuration activated when the MT of the layer-1 forwarding node is in the RRC connected state;
a semi-static forwarding configuration that is activated when the MT of the layer-1 forwarding node is in the RRC connected state and that is not instructed by fourth indication information to be deactivated or released, wherein a release message carries the fourth indication information;
a third semi-static forwarding configuration that a first message received when the MT of the layer-1 forwarding node is in the RRC connected state instructs to reserve in the first state, wherein the first message is used to configure a semi-static forwarding configuration in the RRC connected state, and the semi-static forwarding configuration in the RRC connected state comprises the third semi-static forwarding configuration; or
a fourth semi-static forwarding configuration that is indicated in a second message received when the MT of the layer-1 forwarding node is in the RRC connected state and that keeps active in the first state, wherein the second message is used to configure a semi-static forwarding configuration that is activated for the layer-1 forwarding node when the MT of the layer-1 forwarding node is in the RRC connected state, and the semi-static forwarding configuration that is activated for the layer-1 forwarding node when the MT of the layer-1 forwarding node is in the RRC connected state comprises the fourth semi-static forwarding configuration.

11. The method according to claim 10, further comprising:
receiving, by the layer-1 forwarding node, a third message from the network side device, wherein the third message is used to activate or deactivate the semi-static forwarding configuration.

12. The method according to claim 11, wherein the third message is transmitted by using a radio resource or a physical channel configured by the first configuration information, and the first forwarding configuration information comprises the first configuration information.

13. The method according to claim 11, wherein a quantity of transmission times of the third message is greater than or equal to 1.

14. The method according to claim 11, further comprising:
skipping, by the layer-1 forwarding node, sending a response message of the third message.

15. An information transmission method, comprising:
sending, by a network side device, first forwarding configuration information to a layer-1 forwarding node when a mobile termination module (MT) of the layer-1 forwarding node is in a radio resource control (RRC) connected state, wherein the first forwarding configuration information is used to configure forwarding behavior of the layer-1 forwarding node when the MT of the layer-1 forwarding node enters a first state, and the first state comprises an RRC idle state or an RRC inactive state.

16. The method according to claim 15, wherein the first forwarding configuration information comprises information about a semi-static forwarding configuration, and the semi-static forwarding configuration is configured to configure forwarding behavior of the layer-1 forwarding node after the MT of the layer-1 forwarding node enters the first state.

17. The method according to claim 16, wherein the semi-static forwarding configuration is used to configure at least one of the following:
a length of a forwarding window, a time offset of a forwarding window, a time periodicity of occurrence of a forwarding window, or forwarding beam indication information, wherein
when the semi-static forwarding configuration is activated, the layer-1 forwarding node performs forwarding in a forwarding window determined based on the semi-static forwarding configuration.

18. A layer-1 forwarding node, comprising: a memory storing a computer program; and a processor coupled to the memory and configured to execute the computer program to perform operations comprising:
receiving first forwarding configuration information from a network side device when a mobile termination module (MT) of the layer-1 forwarding node is in a radio resource control (RRC) connected state; and
performing forwarding based on the first forwarding configuration information when the MT of the layer-1 forwarding node enters a first state, wherein the first state comprises an RRC idle state or an RRC inactive state.

19. The layer-1 forwarding node according to claim 18, wherein the first forwarding configuration information comprises information about a semi-static forwarding configuration; and
the performing forwarding based on the first forwarding configuration information when the MT of the layer-1 forwarding node enters a first state comprises:
performing forwarding based on the semi-static forwarding configuration when the MT of the layer-1 forwarding node enters the first state.

20. The layer-1 forwarding node according to claim 19, wherein the semi-static forwarding configuration is used to configure at least one of the following:
a length of a forwarding window, a time offset of a forwarding window, a time periodicity of occurrence of a forwarding window, or forwarding beam indication information, wherein
when the semi-static forwarding configuration is activated, the layer-1 forwarding node performs forwarding in a forwarding window determined based on the semi-static forwarding configuration.
